(19) United States
(12) Patent Application Publication
(10) Pub. No.: US 2021/0245270 A1
(43) Pub. Date: Aug. 12, 2021

(54) HOLE SAW ASSEMBLY

(71) Applicant: Kym KEIGHTLLEY, Adelaide (AU)

(72) Inventor: Kym KEIGHTLLEY, Adelaide (AU)

(21) Appl. No.: 16/973,445

(22) PCT Filed: Jun. 12, 2019
(86) PCT No.: PCT/IB2019/054897

§ 371 Date: Dec. 9, 2020

(30) Foreign Application Priority Data
Jun. 12, 2018 (AU) 2018902101

(51) Int. Cl. B23B 51/04; B23B 51/08

(52) U.S. Cl. CPC B23B 51/0406; B23B 51/08

(57) ABSTRACT

A hole saw assembly is provided. The hole saw assembly includes an arbor, a hole saw, a pilot drill and an ejection member. The pilot drill includes a lock receiving groove member. The pilot drill coaxial with the hole saw extends through and beyond the hole saw. The ejection member configured to slide along the pilot drill. The ejection member includes a biasing member and a barrel coaxially aligned with the pilot drill. The ejection member also includes a sleeve coaxially aligned with the barrel. The barrel and the sleeve are configured to axially slide along the pilot drill. The ejection member further includes at least one locking member configured to engage with the lock receiving groove member to restrict the slidable movement of the barrel and the sleeve with respect to the pilot drill.

### FIELD OF THE INVENTION

The present invention generally relates to a hole saw assembly, and, more particularly, to an ejection member used in hole saw assembly to eject a plug formed when a hole saw cuts the plug of a material.

### BACKGROUND OF THE INVENTION

Hole saws or hole cutters are generally used for making holes or enlarging existing holes in different materials such as wood, metal, plastic and concrete etc. These holes saws are generally in the form of a hollow cylinder or a tube, having a circular edge with cutting teeth at one end and a structure for attachment to a power drill or other type of drilling machine at the other end.

Typically, when a desired hole is cut with the help of cutting teeth of the hole saw, a circular cut portion (also known as a plug) of the material is formed, which gets struck within the cylindrical wall of the hole saw. Various structures and mechanisms have been devised to remove or allow easy removal of the plug formed within the hole saw. One such mechanism utilizes a plate cooperating with a spring located within the cylindrical wall of the hole saw to eject the plugs formed during the cutting process. However, dust or particles from the sawing of the hole may slow or hinder the ejection of the plug out of the hole saw. Accordingly, it is objective of the present invention to overcome above mentioned problem and provide a mechanism and a method to effectively eject the plug out of the hole saw.

### SUMMARY OF THE INVENTION

In view of the foregoing disadvantages inherent in the prior art, the general purpose of the present invention is to provide a dispensing system to include all advantages of the prior art, and to overcome the drawbacks inherent in the prior art.

In one aspect of the present invention, a hole saw assembly is provided. The hole saw assembly includes an arbor, a hole saw, a pilot drill and an ejection member. The hole saw removably coupled to the arbor. The pilot drill removably coupled to the arbor. The pilot drill coaxial with the hole saw extends through and beyond the hole saw. The ejection member configured to slide along the pilot drill. The ejection member includes a biasing member. The ejection member also includes a barrel coaxially aligned with the pilot drill. The ejection member further including a sleeve coaxially aligned with the barrel. The barrel and the sleeve are configured to engage with the lock receiving groove member to restrict the slidable movement of the barrel and the sleeve with respect to the pilot drill. The arbor includes an arbor shaft and an annulus having a plurality of apertures. The hole saw includes a boss and a hole saw cup having a plurality of cutting teeth. The boss includes a plurality of pins. The pins are configured to engage the apertures of the annulus, thereby coupling the hole saw and the arbor. The ejection member includes two locking members. The locking member is a steel ball bearing. The sleeve includes a first step, a second step and a space. The space is defined between the first step and the second step and is configured to receive at least one locking member during operation of the hole saw assembly.

In an embodiment, the barrel includes a flange extending towards the sleeve, a central through bore and at least one lock receiving hole member. The at least one locking member is fitted inside the at least one lock receiving hole member and is free to travel in the at least one lock receiving hole member. The barrel includes two lock receiving hole members positioned radially 180 degrees apart. The sleeve is configured to move between a first position and a second position. In the first position the second step abuts the at least one locking member moving it down the at least one lock receiving hole member towards the lock receiving groove member and into engagement with the lock receiving groove member of the pilot drill. In the second position the at least one locking member is free to move away from the lock receiving groove member and travel up the at least one lock receiving hole member and into the space defined by the barrel.

In another aspect of the present invention, an ejection member is provided. The ejection member includes a barrel and a sleeve coaxial with the barrel. The sleeve includes an inner surface and an outer surface. The barrel is disposed within the inner surface. The ejection member further includes at least one locking member. The ejection member includes a biasing member provided between the barrel and the sleeve.

In yet another aspect of the invention, a method for removing a plug formed during cutting operation of a hole by a hole saw assembly is provided. The method includes disengaging a hole saw from an arbor. The method also includes sliding the hole saw and an ejection member along a pilot drill until the ejection member engages a lock receiving groove member of the pilot drill. The method further includes sliding the hole saw towards the mounting end of the pilot drill exposing the plug. The method includes removing the plug formed during cutting operation. The method also includes inserting a reset key into the hole saw assembly to disengage the ejection member from the lock receiving groove member of the pilot drill.

This together with the other aspects of the present invention, along with the various features of novelty that characterize the present invention, is pointed out with particularity in the claims annexed hereto and forms a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1A illustrates a perspective view of the hole saw assembly including an arbor, a hole saw, a pilot drill and an ejection member in the reset position ready to cut a hole, in accordance with an embodiment of the present invention;

FIG. 1B illustrates a longitudinal sectional view of the hole saw assembly of FIG. 1A along the line A-A′, in accordance with an embodiment of the present invention;

FIG. 2A illustrates a hole saw assembly including the arbor, the hole saw, the pilot drill and the ejection member after cutting a hole, the hole saw therefore containing a plug, in accordance with an embodiment of the present invention;

FIG. 2B illustrates a longitudinal sectional view of the hole saw assembly of FIG. 2A along the line B-B′, in accordance with an embodiment of the present invention;

FIG. 3A illustrates a perspective view of the hole saw assembly including the arbor, the hole saw, the pilot drill and the ejection member ejecting the plug formed during the cutting process, in accordance with an embodiment of the present invention;

FIG. 3B illustrates a longitudinal sectional view of the hole saw assembly of FIG. 3A along the line C-C′, in accordance with an embodiment of the present invention;

FIG. 4A illustrates the hole saw assembly including the arbor, the hole saw, the pilot drill, the ejection member and a rest key, in accordance with an embodiment of the present invention;

FIG. 4B illustrates a section view of the hole saw assembly and the reset key of FIG. 4A along the line D-D′, in accordance with an embodiment of the present invention;

FIG. 5A illustrates the hole saw assembly including the arbor, the hole saw, the pilot drill, the ejection member and the rest key being pushed against the sleeve, in accordance with an embodiment of the present invention;

FIG. 5B illustrates a sectional view of the hole saw assembly and the reset key of FIG. 5A along the line E-E′, in accordance with an embodiment of the present invention;

FIG. 6A illustrates the pilot drill and the ejection member in a first position, in accordance with an embodiment of the present invention;

FIG. 6B illustrates cross sectional view of the ejection member and the pilot drill of FIG. 6A along the line F-F′, in accordance with an embodiment of the present invention;

FIG. 7A illustrates the pilot drill and the ejection member in a second position, in accordance with an embodiment of the present invention;

FIG. 7B illustrates cross sectional view of the ejection member and the pilot drill of the FIG. 7A along the line G-G′, in accordance with an embodiment of the present invention; and

FIG. 8 illustrates a method of removing the plug formed during the cutting process by the hole saw assembly, in accordance with an embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The terms, “a” and “an” herein do not denote a limitation of quantity, but rather denote the presence of at least one of the referenced items.

The present invention provides a hole saw assembly. The hole saw assembly includes an arbor, a hole saw, a pilot drill and an ejection member. The hole saw removably coupled to the arbor. The pilot drill removably coupled to the arbor. The pilot drill coaxial with the hole saw extends through and beyond the hole saw. The ejection member configured to slide along the pilot drill. The ejection member includes a biasing member. The ejection member also includes a barrel coaxially aligned with the pilot drill. The ejection member further including a sleeve coaxially aligned with the barrel. The barrel and the sleeve are configured to engage with the lock receiving groove member to restrict the slidable movement of the barrel and the sleeve with respect to the pilot drill.

The present invention also provides an ejection member. The ejection member includes a barrel and a sleeve coaxial with the barrel. The sleeve includes an inner surface and an outer surface. The barrel is disposed within the inner surface. The ejection member further includes at least one locking member. The ejection member includes a biasing member provided between the barrel and the sleeve.

The present invention further provides a method for removing a plug formed during cutting operation of a hole by a hole saw assembly. The method includes disengaging a hole saw from an arbor. The method also includes sliding the hole saw and an ejection member along a pilot drill until the ejection member engages a lock receiving groove member of the pilot drill. The method further includes sliding the hole saw towards the mounting end of the pilot drill exposing the plug. The method includes removing the plug formed during cutting operation. The method also includes inserting a reset key into the hole saw assembly to disengage the ejection member from the lock receiving groove member of the pilot drill.

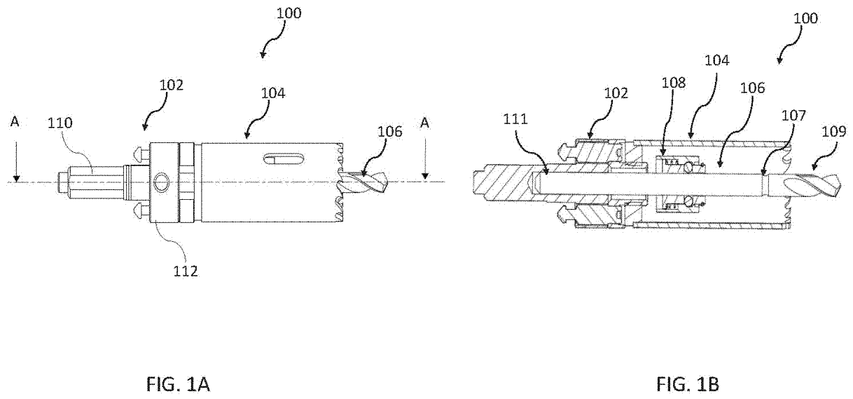

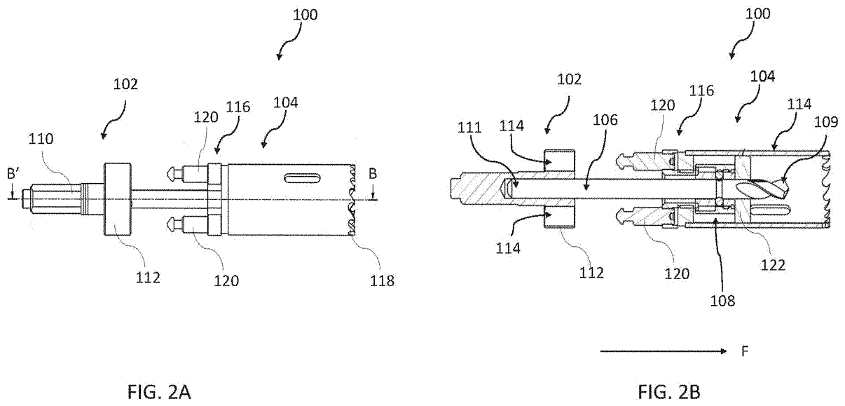

Referring to FIGS. 1A, 1B, 2A and 2B, a hole saw assembly 100 is illustrated. The hole saw assembly 100 includes an arbor 102, a hole saw 104, a pilot drill 106, and an ejection member 108. The arbor 102 (herein after alternatively referred to as mandrel 102) assures reliable engagement of the hole saw assembly 100 with a chuck of a drill used to drive it. The arbor 102 includes an arbor shaft 110 (also known as shank) and an annulus 112 (also known as a collar). The arbor shaft 110 is hexagonal in shape and is adapted to engage with the chuck of a power or a hand drill. The annulus 112 includes plurality of apertures 114, as seen in FIG. 2B. In the illustrated example, the annulus 112 includes two apertures 114. The pilot drill 106 is removably coupled to the arbor 102. In one arrangement, the pilot drill 106 is seated in a hole in an end of the annulus 112 of the arbor 102. The pilot drill 106 extends in diametrically opposite direction with respect to the arbor shaft 110. The pilot drill 106 includes a cutting face 109, a mounting end 111 and a lock receiving groove member 107. The cutting face 109 is disposed opposite to the mounting end 111. The mounting end 111 of the pilot drill 106 is seated in the hole in the annulus 112 of the arbor 102. The pilot drill 106 coaxial with the hole saw 104 extends through and beyond the hole saw 104 such that, during the cutting operation, the cutting face 109 of the pilot drill 102 is the first part to the engage a surface (not shown) of the material (not shown) such as concrete, wood, etc. to be bored. The lock receiving groove member 107 is a circumferential groove around the pilot drill 106. The lock receiving groove member 107 is disposed near to the cutting face 109.

The hole saw 104 includes a hole saw cup 114 and a boss 116. The hole saw cup 114 is removably coupled to the boss 116. The hole saw cup 114 is cylindrical shaped member. The hole saw cup 114 includes a plurality of cutting teeth 118 disposed on an end opposite to an end which couples with the boss 116. The boss 116 includes a plurality of pins 120. The plurality of pins 120 are configured to engage and disengage with the plurality of apertures 114 provided on the annulus 112, thereby coupling and decoupling the boss 116 and the arbor 102 respectively. Further, the plurality of pins 120 prevent the hole saw 104 from rotating with respect to the arbor 102 when the hole saw assembly 100 is being used to cut a hole in the material. During operation the cutting teeth 118 of the hole saw cup 114 is the second part to engage the surface of the material to be bored.

During operation of the hole saw assembly 100, a hole (not shown) is bored from the surface of the material to be bored, this generates a plug 122 (hereinafter alternatively referred to as circular cut portion 122), which usually gets nested or struck within the hole saw cup 114 of the hole saw 104. The hole saw assembly 100 includes the ejection member 108 to remove the plug 122 nested or struck within the hole saw cup 114. The ejection member 108 is configured to slide along the pilot drill 106. The pilot drill 106, the hole saw 104, the arbor 102 and the ejection member 108 are coaxially aligned along a central axis X-X′ (shown in FIG. 1B) of the hole saw assembly 100.

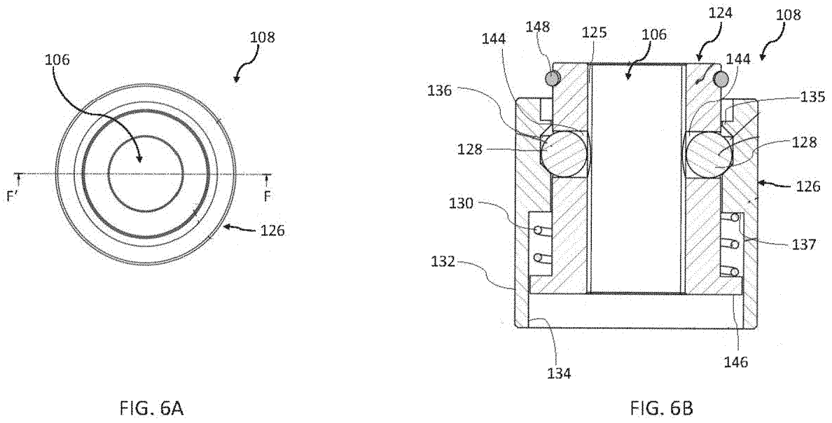

Referring to FIGS. 2A, 2B, 6A, 6B, 7A and 7B, the ejection member 108 includes a barrel 124, a sleeve 126, at least one locking member 128 and a biasing member 130. In the illustrated example, the at least one locking member 128 embodies two steel ball bearings. In the illustrated example, the ejection member 108 includes two locking members 128. Alternatively, the ejection member 108 may include one or more than one locking member 128, without limiting the scope of the invention.

The barrel 124 is cylindrical in shape and is coaxially aligned with the pilot drill 106. The barrel 124 includes a central through bore 125 along its length. The diameter of the central through bore 125 is enough to allow the pilot drill 106 to extend through the central through bore 125. The barrel 124 is movable along the longitudinal axis of the pilot drill 106. The sleeve 126 is coaxially aligned with the barrel 124. The sleeve 126 includes an outer surface 132 and an inner surface 134. The barrel 124 is disposed between the inner surface 134 of the sleeve 126 and the pilot drill 106. The sleeve 126 and the barrel 124 slide along the pilot drill 106 as a single unit. Further, the sleeve 126 and the barrel 124 are configured to slide with respect to one another. The barrel 124 includes at least one lock receiving hole member 144 corresponding to the at least one locking member 128. The lock receiving hole member 144 extends from an outer surface towards a center of the barrel 124. The at least one locking member 128 is fitted inside the at least one lock receiving hole member 144 and is free to travel with the at least one lock receiving hole member 144. In the illustrated example, the barrel 124 includes two lock receiving hole members 144 corresponding to the two locking members 128. The barrel 124 includes a flange 146 which extends towards the inner surface 134 of the sleeve 126 from the barrel 124. The ejection member 108 includes a stop ring 148 fixedly mounted to the barrel 124 to restrict the movement of the barrel 124 with respect to the sleeve 126.

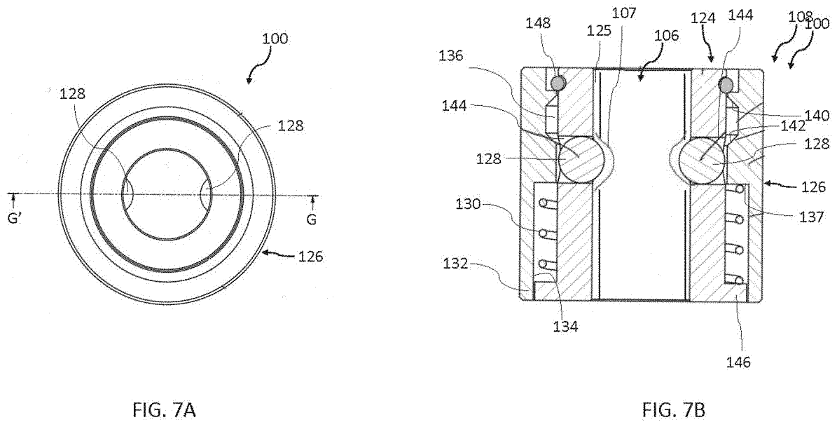

The sleeve 126 surrounds the barrel 124. The sleeve 126 is moved between a first position (engaged position) and a second position (disengaged position). The sleeve 126 is biased to force the locking members 128 towards the center of the lock receiving hole members 144 to engage the lock receiving groove member 107 of the pilot drill 106. The sleeve 126 includes a first step 135, a second step 137 and a space 136 (hereinafter alternatively referred to as annular chamber 136) in the form of an inner annular groove. The first step 135 and the second step 137 of the sleeve 126 extends inwards from the sleeve 126 towards the barrel 124. The first step 135 is configured to engage the stop ring 148 of the barrel 124 to restrict the downward movement of the barrel 124 with respect to the sleeve 126. The space 136 is defined between the first step 135 and the second step 137. The space 136 includes a front side face 140 and rear side face 142 (shown in FIG. 7B). The front side face 140 is inclined so as to converge forward and extends so as to be contiguous with the inner surface 134 of the sleeve 126. The rear side face 142 is inclined so as to converge rearward and extends so as to be contiguous with the inner surface 134 of the sleeve 126. In the first position (as shown in FIG. 2B) the second step 137 abuts the at least one locking member 128 moving it down into the at least one lock receiving hole member 144 towards the lock receiving groove member 107 and into engagement with the pilot drill 106. In second position the at least one locking member is free to move away from the lock receiving groove member 107 and travel up the at least one lock receiving hole member 144 away from lock receiving groove member 107 of the pilot drill 106 and into the space 136 of the barrel 124. The space 136 is configured to receive the at least one locking member 128 in a second position.

In the illustrated example, the biasing member 130 embodies a compression coil spring. The biasing member 130 is disposed between the barrel 124 and the sleeve 126. More particularly, the biasing member 130 is anchored between the flange 146 the barrel 124 and the second step 137 of the sleeve 126. The biasing member 130 provides required biasing force between the sleeve 126 and the barrel 124.

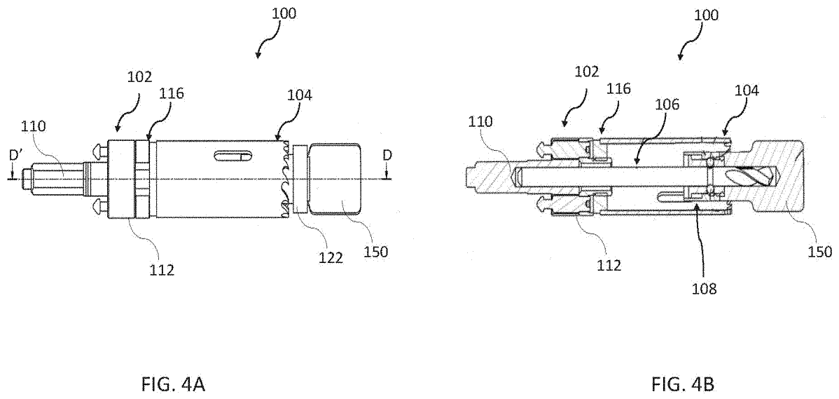

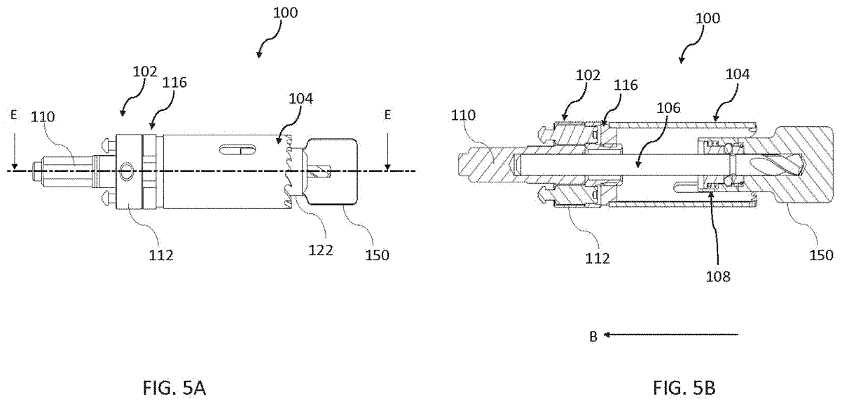

During operation, when a hole is bored by the hole saw assembly 100, the plug 122 formed, gets struck within the hole saw cup 114 (as shown in FIGS. 2A and 2B). To remove the plug 122 the hole saw 104 is disengaged from the arbor 102. The hole saw 104 along with the ejection member 108 is slid towards the front end of the pilot drill 106 in the front direction F (as shown in FIG. 2B). The second step 137 of the sleeve 126 biases the locking members 128 disposed with the space 136 of the sleeve 126 and the lock receiving hole members 144 of the barrel 124 to move into the lock receiving groove member 107 of the pilot drill 106, thereby locking the ejection member 108 in a first position (shown in a FIGS. 7A and 7B). The plug 122 is then removed, thereafter a reset key 150 or fingers of the operator are used to push the sleeve 126 against the biasing force of the biasing member 130 disposed between the sleeve 126 and the barrel 124 (shown in FIGS. 4A, 4B, 5A and 5B). This dislodges the locking members 128 from the lock receiving groove member 107 of the pilot drill 106, thereby sliding the ejection member 108 towards the mounting end 111 of the pilot drill 106 in the rearward direction B (shown in FIG. 5B).

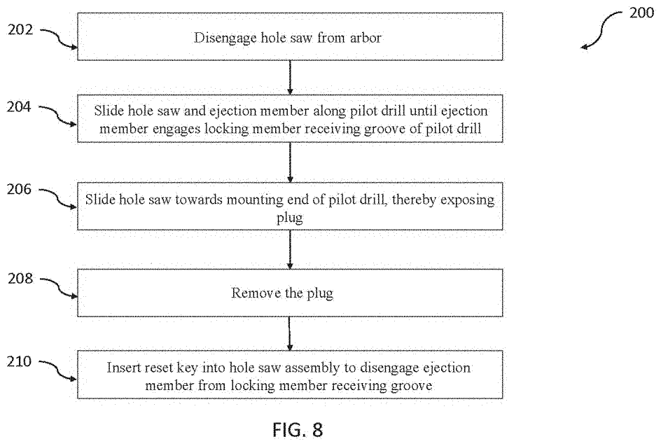

Referring to FIG. 8 a flow chart of a method 200 to remove the plug 122 formed during the cutting operation of the hole by the hole saw assembly is illustrated. At step 202, the hole saw 104 is disengaged from the arbor 102. More particularly, the plurality of pins 120 provided on the boss 116 of the hole saw 104 are disengaged with the plurality of apertures 114 provided on the annulus 112 of the arbor 102, thereby allowing the hole saw 104 to slide along the pilot drill 106.

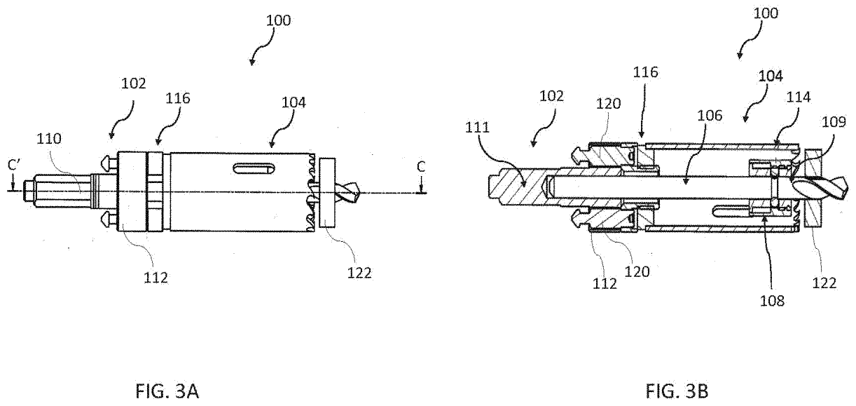

At step 204, the hole saw 104 along with ejection member 108 is slided (guided) along the pilot drill 106 towards a front end of the pilot drill 106 until the ejection member 108 engages the lock receiving groove member 107 More particularly, as the ejection member 108 moves along with the hole saw 104, the sleeve 126 is moved towards a first position, wherein the second step 137 of the sleeve 126 abuts the at least one locking member 128 moving it down into the at least one lock receiving hole member 144 towards the lock receiving groove member 107 and into engagement with the pilot drill 106 (shown in FIGS. 3A and 3B).

At step 206, the hole saw 104 is slid towards the mounting end 111 of the pilot drill 106, thereby exposing the plug 122 (shown in FIGS. 3A and 3B). At step 208, the plug 122 formed during the cutting operation is removed. At step 210, a reset key 150 is inserted into the hole saw assembly 100 to disengage the ejection member 108 from the lock receiving groove member 107 of the pilot drill 106 (shown in FIGS. 4A, 4B, 5A and 5B). More particularly, the sleeve 126 is moved towards a second position. In second position the at least one locking member is free to move away from the lock receiving groove member 107 and travel up the at least one lock receiving hole member 144 away from lock receiving groove member 107 of the pilot drill 106 and into the space 136 of the barrel 124, thereby disengaging the ejection member 108. Fingers of an operator may also be used instead of a reset key 150 to disengage the ejection member 108 from the lock receiving groove member 107, without limiting the scope of the invention. The method 200 enables removal of the plug 122 formed during the cutting process by implementing the steps of the method 200. With such an implementation, the wedged and struck plugs within the hole saw cup 114 of the hole saw 104 are adequately cleared.

The hole saw assembly 100 and the method 200 disclosed above, provides efficient removal of the plug 122 formed during the cutting operation of the material, from the hole saw 104. The ejection member 108 of the hole saw assembly 100 provides an efficient and cost-effective solution for removal the unwanted plugs such as the plug 122 formed during the cutting operation.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A hole saw assembly comprising:
an arbor;
a hole saw removably coupled to the arbor;
a pilot drill removably coupled to the arbor, the pilot drill having a lock receiving groove member, wherein the pilot drill is coaxial with the hole saw, and extends through and beyond the hole saw; and
an ejection member configured to slide along the pilot drill, the ejection member having,
a biasing member,
a barrel coaxially aligned with the pilot drill,
a sleeve coaxially aligned with the barrel, the barrel and the sleeve are configured to axially slide along the pilot drill, and
at least one locking member, wherein the at least one locking member is configured to engage with the lock receiving groove member to restrict the slidable movement of the barrel and the sleeve with respect to the pilot drill.

2. The hole saw assembly according to claim 1, wherein the arbor comprises an arbor shaft, and an annulus having a plurality of apertures.

3. The hole saw assembly according to claim 1, wherein the hole saw comprises a boss, and a hole saw cup having a plurality of cutting teeth.

4. The hole saw assembly according to claims 2 and 3, wherein the boss comprises a plurality of pins, wherein the pins are configured to engage the apertures of the annulus, thereby coupling the hole saw and the arbor.

5. The hole saw assembly according to claim 1, wherein the ejection member comprises two locking members, wherein the locking member is a steel ball bearing.

6. The hole saw assembly according to claim 1, wherein the sleeve comprises a first step, a second step and a space, wherein the space is defined between the first step and the second step and is configured to receive the at least one locking member during operation.

7. The hole saw assembly according to claim 1, wherein the barrel comprises a flange extending towards the sleeve, a central through bore and at least one lock receiving hole member, wherein the at least one locking member is fitted inside the at least one lock receiving hole member and is free to travel in the at least one lock receiving hole member.

8. The hole saw assembly according to claim 7, wherein the barrel comprises two lock receiving hole members positioned radially 180 degrees apart.

9. The hole saw assembly according to claims 6 and 7, wherein the sleeve is configured to move between:
a first position, wherein in the first position, the second step abuts the at least one locking member moving it down the at least one lock receiving hole member towards the lock receiving groove member and into engagement with the lock receiving groove member of the pilot drill; and
a second position, wherein in the second position, the at least one locking member is free to move away from the lock receiving groove member and travel up the at least one lock receiving hole member and into the space defined by the barrel.

10. The hole saw assembly according to claims 6 and 7, wherein the biasing member is disposed between the flange and the second step.

11. The hole saw assembly according to claim 1, wherein the ejection member comprises a stop ring fixedly mounted on the barrel, wherein the stop ring restricts the movement of the barrel with respect to the sleeve.

12. The hole saw assembly according to claim 1, wherein the sleeve is biased to force the at least one locking member towards a center of the barrel to engage the lock receiving groove member of the pilot drill.

13. The hole saw assembly according to claim 1, wherein the pilot drill, the hole saw, the arbor and the ejection member are coaxially aligned.

14. An ejection member comprising:
a barrel;
a sleeve coaxial with the barrel, wherein the sleeve comprises an inner surface and an outer surface, wherein the barrel is disposed within the inner surface;
at least one locking member; and
a biasing member disposed between the barrel and the sleeve.

15. The ejection member according to claim 14, wherein the barrel comprises at least one lock receiving hole member corresponding to the at least one locking member.

16. The ejection member according to claim 15, wherein the barrel comprises two lock receiving hole members positioned radially 180 degrees apart.

17. The ejection member according to claim 14, wherein the ejection member comprises two locking members, wherein the locking member is a steel ball bearing.

18. The ejection member according to claim 14, wherein the ejection member comprises a stop ring fixedly mounted on the barrel, wherein the stop ring restricts the movement of the barrel with respect to the sleeve.

19. The ejection member according to claim 14, wherein the sleeve comprises a first step, a second step and a space, wherein the space is defined between the first step and the second step.

20. A method for removing a plug formed during cutting operation of a hole by a hole saw assembly, the method comprising:
disengaging a hole saw from an arbor;
sliding the hole saw and an ejection member along a pilot drill until the ejection member engages a lock receiving groove member of the pilot drill;
sliding the hole saw towards a mounting end of the pilot drill;
removing the plug; and
inserting a reset key to disengage the ejection member from the lock receiving groove member of the pilot drill.
